(19) United States
(12) Patent Application Publication
(10) Pub. No.: US 2025/0112347 A1
(43) Pub. Date: Apr. 3, 2025

(54) METHOD OF MANUFACTURING BATTERY

(71) Applicant: TOYOTA JIDOSHA KABUSHIKI KAISHA, Toyota-shi (JP)

(72) Inventors: Yosuke SHIMURA, Nagakute-shi (JP); Takahiko NAKANO, Nagoya-shi (JP); Hirokazu TAKEUCHI, Toyota-shi (JP); Masato NODA, Toyota-shi (JP); Atsushi SUGIHARA, Toyota-shi (JP); Jun IZUMI, Toyota-shi (JP); Yuka YOKOI, Nagoya-shi (JP)

(21) Appl. No.: 18/823,517

(22) Filed: Sep. 3, 2024

(30) Foreign Application Priority Data
Oct. 2, 2023 (JP) 2023-171530

(51) Int. Cl. H01M 50/627; H01M 50/249; H01M 50/618

(52) U.S. Cl. CPC H01M 50/627; H01M 50/249; H01M 50/618

(57) ABSTRACT

A method of manufacturing a battery includes disposing, in an internal space of an exterior body 11, an electrode body 12 and a plate 13 that has a groove formed at a surface of the plate 13; and supplying an electrolytic solution 14 to the exterior body 11 so that at least a part of the electrode body and at least a part of the plate are immersed in the electrolytic solution 14.

### CROSS-REFERENCE TO RELATED APPLICATION

This application is based on and claims priority under 35 USC 119 from Japanese Patent Application No. 2023-171530 filed on Oct. 2, 2023, the disclosure of which is incorporated by reference herein.

### BACKGROUND

### Technical Field

The present disclosure relates to a method of manufacturing a battery.

### Related Art

In the manufacturing process of a battery using a liquid electrolyte (an electrolytic solution), a liquid injection operation is performed in which an electrolytic solution is permeated into an electrode that contains an electrode active material.

In some cases, a process is performed by which an electrode of a battery is pressed at a high pressure in order to increase the energy density. When the packing density of the electrode active material in the electrode is increased by pressing the electrode, the permeability of the electrolytic solution decreases. The decrease in the permeability of the electrolytic solution causes a decrease in the efficiency of the liquid injection operation.

As a measure to enhance the permeability of an electrolytic solution at the time of a liquid injection operation, Japanese Patent Application Laid-Open (JP-A) No. 2002-15773 proposes using a groove that is provided at a surface of an electrode or a separator as a flow passage for the electrolytic solution.

In the method described in JP-A No. 2002-15773, since a step of providing a groove at a surface of an electrode or a separator is required, there is a possibility that the efficiency of the entire manufacturing process of a battery is reduced. Further, by providing a groove in the electrode, the energy density of the battery may decrease.

### SUMMARY

In view of the foregoing, an embodiment of the present disclosure is directed to a novel method of manufacturing a battery in which the efficiency of a liquid injection operation of an electrolytic solution is improved.

The means for solving the above-described problem includes the following embodiments.

<1> A method of manufacturing a battery, the method comprising:
disposing, in an internal space of an exterior body, an electrode body and a plate that has a groove formed at a surface of the plate; and
supplying an electrolytic solution to the exterior body so that at least a part of the electrode body and at least a part of the plate are immersed in the electrolytic solution.

<2> The method of manufacturing a battery according to <1>, wherein a direction of the groove of the plate is perpendicular to a liquid level.

<3> The method of manufacturing a battery according to <1> or <2>, wherein the surface of the plate at which the groove is formed is in contact with an end surface of the electrode body.

<4> The method of manufacturing a battery according to <1> or <2>, the method comprising:

causing at least a part of the electrolytic solution to move along the groove of the plate to a region above a liquid level.

<5> The method of manufacturing a battery according to <1> or <2>, the method comprising:
depressurizing the internal space of the exterior body.

### BRIEF DESCRIPTION OF THE DRAWINGS

Exemplary embodiments of the present disclosure will be described in detail based on the following figures, wherein:

FIG. 1 is a diagram schematically illustrating an example of a method of manufacturing a battery;

FIG. 2 is a diagram schematically illustrating an example of application to a battery module of an electric vehicle;

FIG. 3 is a diagram schematically illustrating an example of a configuration of a battery module;

FIG. 4 is a diagram schematically illustrating an example of a configuration of a battery module; and

FIG. 5 is a diagram schematically illustrating an example of a configuration of a battery cell included in a battery module.

### DETAILED DESCRIPTION

In the present disclosure, a numerical value range expressed by using “(from) . . . to . . . ”, means a range in which the numerical values before and after the word “to” are included as the minimum value and the maximum value, respectively.

In the numerical value ranges that are expressed in a stepwise manner in the present disclosure, the upper limit value or the lower limit value described in a given numerical value range may be replaced with the upper limit value or the lower limit value of another numerical value range that is expressed in a stepwise manner. In the numerical value ranges described in the present disclosure, the upper limit value or the lower limit value described in a given numerical range may be replaced with a value shown in the examples.

In the present disclosure, the term “step” includes not only an independent step, but also a step that cannot be clearly distinguished from another step as long as the intended purpose of the step is achieved.

In the case in which embodiments are described in the present disclosure with reference to the drawings, the configuration of an embodiment is not limited to the configuration illustrated in the drawings. Further, the sizes of the members in the drawings are conceptual, and the relative relationship between the sizes of the members is not limited thereto.

A method of manufacturing a battery of the present disclosure includes a step of disposing, in an internal space of an exterior body, an electrode body and a plate having a groove formed at a surface of the plate, and a step of supplying an electrolytic solution to the exterior body so that at least a part of the electrode body and at least a part of the plate are immersed in the electrolytic solution.

When an electrolytic solution is supplied to an internal space of an exterior body, the portion of the supplied electrolytic solution, which is not absorbed by an electrode body immediately after the supplying, remains in the internal space of the exterior body.

The waiting time until the electrolytic solution remaining in the internal space of the exterior body is absorbed by the electrode body can cause a decrease in operation efficiency. In particular, in a case in which the electrolytic solution is supplied over plural separate times, if the above-described waiting time is long, the operation efficiency tends to decrease.

In this regard, in the method of the present disclosure, a plate having a groove formed at a surface of the plate is disposed in the internal space of the exterior body together with the electrode body. The groove of the plate induces capillary action of the electrolytic solution, whereby at least a part of the electrolytic solution moves above a liquid level. As a result, the opportunity for contact between the electrode body and the electrolytic solution is increased, and the waiting time until the electrolytic solution is absorbed by the electrode body is shortened.

Further, since the method of the present disclosure can be performed without processing of the electrode body, the method of the present disclosure has high versatility. Hereinafter, the step of disposing, in the internal space of the exterior body, the electrode body and the plate having a groove formed at the surface of the plate is also referred to as “step 1”, and the step of supplying the electrolytic solution to the exterior body so that at least a part of the electrode body and at least a part of the plate are immersed in the electrolytic solution is also referred to as “step 2”.

### (Step 1)

In step 1, the electrode body and the plate having a groove formed at the surface of the plate are disposed in the internal space of the exterior body.

The type of the exterior body is not particularly limited, and known exterior bodies such as bag-shaped structures obtained by joining the periphery of a flexible sheet, and metal cans, can be used.

The electrode body includes a layered body consisting of a positive electrode, a separator, and a negative electrode. Examples of the form of the electrode body include a state in which plural layered bodies, which are cut to predetermined dimensions, are overlapped; and a state in which an elongated layered body is wound.

It is preferable that the electrode body is disposed in the internal space of the exterior body so that an end surface of the electrode body (a portion at which a cross-section of the electrode is exposed and which serves as a main inlet of permeation path for the electrolytic solution) is positioned at a side part of the electrode body.

As the plate, a plate in which a groove, capable of inducing movement of the electrolytic solution due to capillary action, is formed at a surface of the plate can be used without any particular limitation.

From the viewpoint of the electrolytic solution being efficiently absorbed by the electrode body, the plate is preferably disposed in the internal space of the exterior body in a state in which the surface of the plate at which the groove is formed is in contact with the end surface of the electrode body.

The direction of the groove of the plate that is disposed in the internal space of the exterior body is preferably a direction that is perpendicular to the liquid level.

The number of plates disposed in the internal space of the exterior body may be one or two or more.

The dimensions of the plate are not particularly limited, as long as the plate can be disposed in the internal space of the exterior body together with the electrode body. From the viewpoint of promoting the movement of the electrolytic solution and ease of removal from the exterior body, it is preferable that a dimension L1 in a long-side direction of the plate, and a dimension L2 in a gravitational force direction of the electrode body in a state in which the electrode body is disposed in the internal space of the exterior body, satisfy the requirement of L1≥L2.

### (Step 2)

In step 2, the electrolytic solution is supplied to the exterior body so that at least a part of the electrode body and at least a part of the plate are immersed in the electrolytic solution.

The method of supplying the electrolytic solution to the exterior body is not particularly limited, and can be carried out by a known method.

The number of times that the electrolytic solution is supplied may be one time or plural times.

The portion of the electrolytic solution supplied to the exterior body in step 2, which is not absorbed by the electrode body immediately after the supplying, remains in the internal space of the exterior body. For this reason, there is a time to wait until the electrolytic solution remaining in the internal space of the exterior body is absorbed by the electrode body. During this time, at least a part of the electrolytic solution moves along the groove of the plate to the region above the liquid level.

The method of the present disclosure may include depressurizing the internal space of the exterior body. When the internal space of the exterior body is in a depressurized state, movement of the electrolytic solution along the groove of the plate is promoted, and absorption of the electrolytic solution by the electrode body tends to be promoted.

After permeation of a designed amount of the electrolytic solution into the electrode body is completed, the plate is taken out of the exterior body, and an opening of the exterior body is closed. The method of closing the opening of the exterior body is not particularly limited, and can be carried out by a known method.

Explanation follows of embodiments of the present disclosure with reference to the drawings.

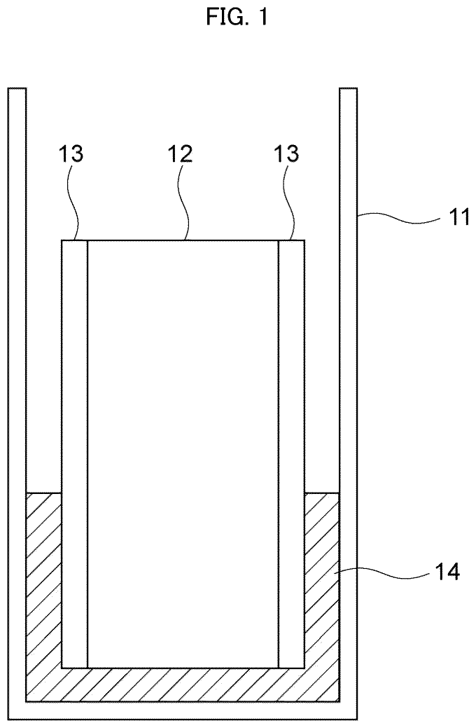

FIG. 1 is a diagram that schematically illustrates an example of a method of manufacturing a battery.

As illustrated in FIG. 1, an electrode body 12 and a plate 13 having a groove formed at a surface of the plate 13 are disposed in an internal space of an exterior body 11.

The electrode body 12 has an end surface at a side part thereof, and the plate 13 is disposed so as to contact the end surface of the electrode body 12. The plate 13 has a groove (not illustrated), which is formed in a direction that is perpendicular to the liquid level, at a surface in contact with the end surface of the electrode body 12.

A portion of a supplied electrolytic solution 14, which is not absorbed by the electrode body 12 immediately after supply, remains in the internal space of the exterior body 11. Each of the electrode body 12 and the plate 13 is in a state in which a part thereof is immersed in the electrolytic solution 14.

At least a part of the electrolytic solution 14 remaining in the internal space of the exterior body 11 moves along the groove of the plate 13 to above the liquid level due to capillary action. The electrolytic solution 14, which has moved along the groove of the plate 13, contacts the end surface of the electrode body 12 in a region above the liquid level of the electrolytic solution 14, and is absorbed by the electrode body 12.

When a sufficient amount of the electrolytic solution 14 is absorbed by the electrode body 12, the step of supplying the electrolytic solution 14 to the internal space of the exterior body 11 is repeated as necessary.

When the designed amount of the electrolytic solution 14 is supplied to the exterior body 11, the opening of the exterior body 11 is sealed.

In an embodiment, the material that configures the exterior body 11 may be a lamina ted body (so-called laminate film) having a metal layer containing a metal such as aluminum and a heat seal layer containing a resin that is melted by heating. In other words, a battery 10 may be a battery (so-called laminate battery) including the exterior body 11 obtained by bon ding the periphery of a laminate film.

The exterior body 11 may be configured from one member, or may be configured fr om two or more members.

### (Battery)

The type of battery that is manufactured by the method of the present disclosure is not particularly limited.

Specific examples of the battery include secondary batteries such as lithium-ion secondary batteries, lead storage batteries, nickel-hydrogen storage batteries, nickel-cadmium storage batteries, nickel-iron storage batteries, nickel-zinc storage batteries, silver oxide-zinc storage batteries, and cobalt-titanium-lithium secondary batteries.

From the viewpoint of energy density, versatility, and the like, the battery may be a lithium-ion secondary battery.

A lithium-ion secondary battery includes, for example, a positive electrode, a negative electrode, a separator that is disposed between the positive electrode and the negative electrode, and an electrolytic solution.

The positive electrode includes, for example, a current collector and a positive electrode layer that is disposed on the current collector. The positive electrode layer contains a positive electrode active material.

Examples of the positive electrode active material include composite oxides formed of lithium and a transition metal, and optionally other metals (hereinafter, also referred to as lithium transition metal composite oxides). Examples of transition metals and other metals include Ni, Co, Mn, Al, B, Mg, Ti, V, Cr, Fe, Cu, Zn, Ga, Sr, Zr, Nb, In, Sn, Ta, W, and the like.

Examples of the lithium transition metal composite oxides include layered lithium transition metal composite oxides, spinel-type lithium transition metal composite oxides, and olivine-type lithium transition metal composite oxides.

Examples of the layered lithium transition metal composite oxides include those containing at least one selected from Ni, Co or Mn as the transition metal. Specific examples thereof include compounds represented by the structural formula of LiNiₐCo_{b}Mn_{c}O₂ (a, b, and c each being a number of 0 or more and 1 or less, and a+b+c=1), and compounds in which one or more elements selected from Al, Mg, La, Ti, Zn, B, W, Fe, Cr, V, Ru, Cu, Cd, Ag, Y, Sc, Ga, In, As, Sb, Pt, Au, Si, or the like are added to the aforementioned compounds. Specific examples of the spinel-type lithium transition metal complex oxides include LiMn₂O₄.

Specific examples of the olivine-type lithium transition metal complex oxides include LiMPO₄ (M: Fe, Co, Ni or Mn).

The positive electrode active material contained in the positive electrode layer may be a single type or two or more types thereof.

The positive electrode layer may contain, in addition to the positive electrode active material, components such as a conductivity aid and a binder.

Examples of the material that configures the current collector of the positive electrode include aluminum, aluminum alloys, nickel, titanium, and stainless steel. Examples of the shape of the current collector include a foil and a mesh.

The negative electrode includes, for example, a current collector and a negative electrode layer that is disposed on the current collector and that contains a negative electrode active material.

Examples of the type of the negative electrode active material include carbon materials such as graphite, hard carbon, soft carbon, and activated carbon, silicon, metallic lithium, lithium alloys, and lithium titanate (LTO).

The negative electrode layer may contain, in addition to the negative electrode active material, components such as a conductive aid and a binder.

Examples of the material that configures the current collector of the negative electrode include copper, copper alloys, nickel, titanium, and stainless steel. Examples of the shape of the current collector of the negative electrode include a foil and a mesh.

Examples of the separator include nonwoven fabrics, cloths, and microporous films containing a polyolefin, such as polyethylene and polypropylene, as a main component. In a case in which a solid electrolyte is used as the lithium-ion secondary battery, a separator may not be used.

As the electrolytic solution, a solution in which a known lithium salt such as LiPF₆ is dissolved in an organic solvent can be used without any particular limitation.

The battery of the present disclosure may be installed at an electric vehicle. Explanation follows of an example in which the battery of the present disclosure is applied to an electric vehicle, with reference to the drawings. In the following explanation, “battery cell 20” corresponds to the battery of the present disclosure.

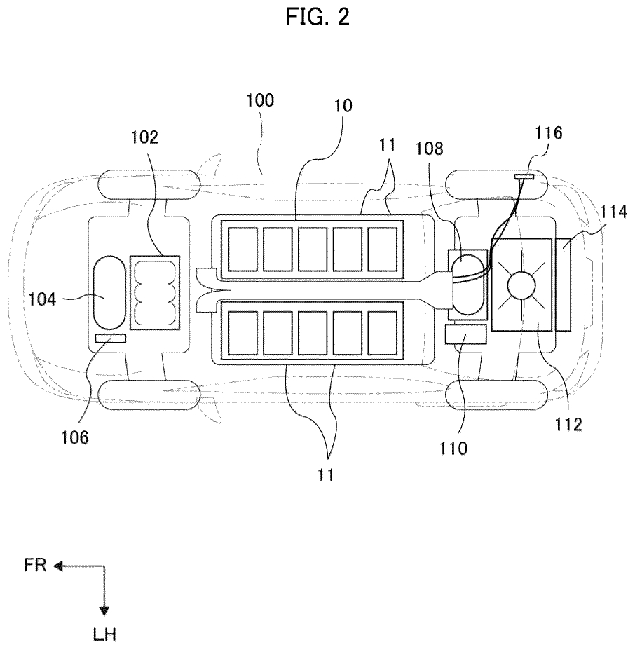

FIG. 2 is a schematic plan view illustrating a main part of a vehicle 100 to which a battery pack 10 according to the embodiment is applied. As illustrated in FIG. 2, the vehicle 100 is an electric vehicle (BEV: Battery Electric Vehicle) to which the battery pack 10 is installed under a floor. Note that in each of the drawings, the arrow UP, the arrow FR, and the arrow LH respectively indicate an upper side in a vehicle up-down direction, a front side in a vehicle front-rear direction, and a left side in a vehicle width direction. Unless specifically stated otherwise, in a case in which front-rear, left-right, and up-down directions are described, these refer to the front and rear in the vehicle front-rear direction, the left and right in the vehicle width direction, and up and down in a vehicle up-down direction.

As an example, in the vehicle 100 of the present embodiment, a DC/DC converter 102, an electric compressor 104, and a positive temperature coefficient (PTC) heater 106 are disposed further to a vehicle front side than the battery pack 10. Further, a motor 108, a gear box 110, an inverter 112, and a charger 114 are disposed further to a vehicle rear side than the battery pack 10.

The DC current output from the battery pack 10 is adjusted in voltage by the DC/DC converter 102, and then supplied to the electric compressor 104, the PTC heater 106, the inverter 112, and the like. Further, by supplying electric power to the motor 108 via the inverter 112, the rear wheels rotate to cause the vehicle 100 to travel.

A charging port 116 is provided at a right side part at a rear part of the vehicle 100. By connecting a charging plug of an external charging facility, which is not illustrated in the drawings, from the charging port 116, electric power can be stored in the battery pack 10 via the charger 114.

The arrangement, structure and the like of each component configuring the vehicle 100 are not limited to the above-described configuration. For example, the present disclosure may be applied to vehicles installed with an engine such as hybrid vehicles (HV) and plug-in hybrid electric vehicles (PHEV). Further, in the present embodiment, although the vehicle is a rear-wheel-drive vehicle with the motor 108 installed at a vehicle rear part, there is no limitation thereto, and the vehicle may be a front-wheel-drive vehicle with the motor 108 installed at a vehicle front part, and a pair of motors 108 may be installed at the front and rear of the vehicle. Furthermore, the vehicle may be provided with an in-wheel motor at each wheel.

The battery pack 10 includes plural battery modules 11. In the present embodiment, as an example, ten battery modules 11 are provided. Specifically, five battery modules 11 are arranged in the vehicle front-rear direction at a right side of the vehicle 100, and five battery modules 11 are arranged in the vehicle front-rear direction at a left side of the vehicle 100. Further, each battery module 11 is electrically connected to each other.

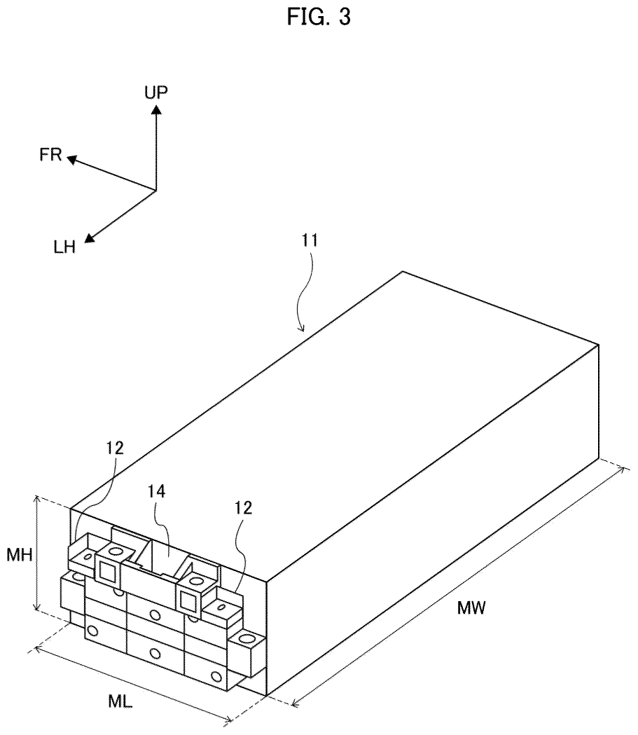

FIG. 3 is a schematic perspective view of the battery module 11. As illustrated in FIG. 3, the battery module 11 is formed in a substantially rectangular parallelepiped shape having the vehicle width direction as a longitudinal direction. Further, an outer shell of the battery module 11 is formed of an aluminum alloy. For example, the outer shell of the battery module 11 is formed by joining aluminum die-casting to both ends of an extruded material of an aluminum alloy by laser welding or the like.

A pair of voltage terminals 12 and a connector 14 are provided at both ends of the battery module 11 in the vehicle width direction. A flexible printed circuit board 21, which is described below, is connected to the connector 14. Further, bus bars (not illustrated) are welded to both ends of the battery module 11 in the vehicle width direction.

A length MW of the battery module 11 in the vehicle width direction is, for example, from 350 mm to 600 mm; a length ML in the vehicle front-rear direction is, for example, from 150 mm to 250 mm; and a height MH in the vehicle up-down direction is, for example, from 80 mm to 110 mm.

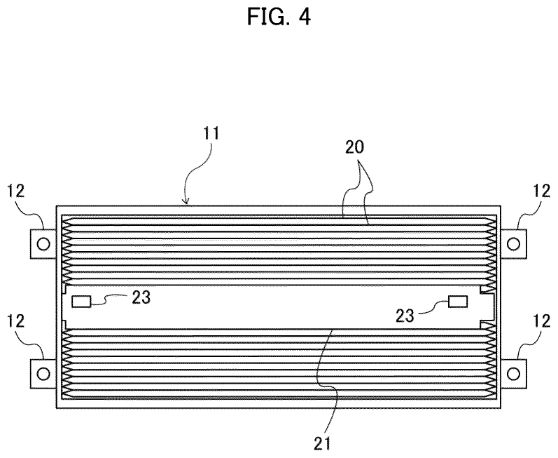

FIG. 4 is a plan view of the battery module 11 in a state in which an upper lid is removed. As illustrated in FIG. 4, plural battery cells 20 are housed in the interior of the battery module 11 in an arranged state. In the present embodiment, as an example, twenty-four battery cells 20 are arranged in the vehicle front-rear direction and are adhered to each other.

A flexible printed circuit (FPC) board 21 is arranged on the battery cell 20. The flexible printed circuit board 21 is formed in a band shape with the vehicle width direction as a longitudinal direction, and thermistors 23 are provided at both end parts of the flexible printed circuit board 21. The thermistors 23 are not adhered to the battery cell 20 and are configured so as to be pressed toward the battery cell 20 side by the upper lid of the battery module 11.

Further, one or more cushioning materials (not illustrated) are housed inside the battery module 11. For example, the cushioning material is a thin plate-shaped member which is elastically deformable, and is disposed between adjacent battery cells 20 with an arrangement direction of the battery cells 20 as a thickness direction. In the present embodiment, as an example, cushioning materials are disposed at both end parts in the longitudinal direction of the battery module 11 and at the center part in the longitudinal direction of the battery module 11, respectively.

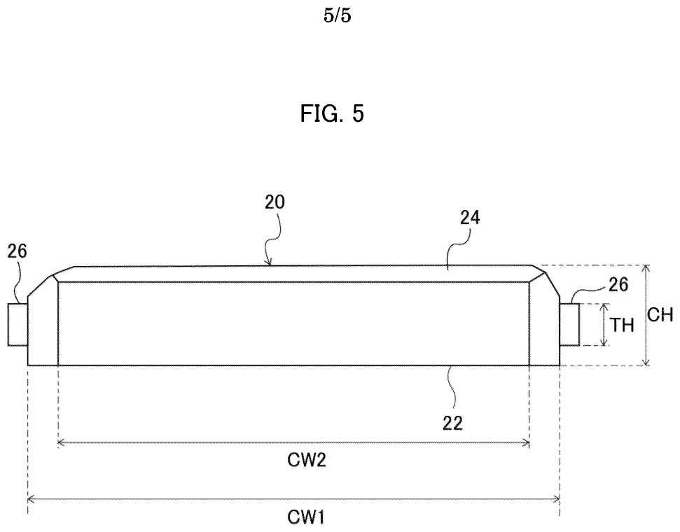

FIG. 5 is a schematic view of the battery cell 20 housed in the battery module 11, as viewed in the thickness direction. As illustrated in FIG. 5, the battery cell 20 is formed in a substantially rectangular plate shape, and an electrode body (not illustrated) is housed therein. The electrode body is configured by layering a positive electrode, a negative electrode, and a separator, and is sealed by a laminate film 22.

In the present embodiment, as an example, the embossed sheet-shaped laminate film 22 is folded and bonded to form a housing part of the electrode body. The laminate film 22 may have either a single-cup embossing structure in which embossing is at one place or a double-cup embossing structure in which embossing is at two places. In an embodiment, the laminate film 22 has a single-cup embossing structure with a draw depth of from about 8 mm to 10 mm.

The upper ends of both ends of the battery cell 20 in the longitudinal direction are folded over, and the corners thereof have a contour. Further, an upper end part of the battery cell 20 is folded over, and a fixing tape 24 is wound around the upper end part of the battery cell 20 along the longitudinal direction.

Terminals (tabs) 26 are provided at both ends in the longitudinal direction of the battery cell 20. In the present embodiment, as an example, the terminal 26 is provided at a position offset downward from the center of the battery cell 20 in the up-down direction. The terminal 26 is connected to a bus bar (not illustrated) by laser welding or the like.

For example, the battery cell 20 has a length CW1 in the vehicle width direction of from 530 mm to 600 mm, from 600 mm to 700 mm, from 700 mm to 800 mm, from 800 mm to 900 mm, or greater than or equal to 1000 mm; a length CW2 of the region in which the electrode body is housed of from 500 mm to 520 mm, from 600 mm to 700 mm, from 700 mm to 800 mm, from 800 to 900 mm, or greater than or equal to 1000 mm; a height CH of from 80 mm to 110 mm or from 110 mm to 140 mm; a thickness of from 5.0 mm to 7.0 mm, from 7.0 mm to 9.0 mm, or from 9.0 mm to 11.0 mm; and a height TH of the terminal 26 of from 40 mm to 50 mm, from 50 mm to 60 mm, or from 60 mm to 70 mm.

All publications, patent applications, and technical standards mentioned in the present specification are incorporated herein by reference to the same extent as if each individual publication, patent application, or technical standard was specifically and individually indicated to be incorporated by reference.

What is claimed is:

1. A method of manufacturing a battery, the method comprising:
disposing, in an internal space of an exterior body, an electrode body and a plate that has a groove formed at a surface of the plate; and
supplying an electrolytic solution to the exterior body so that at least a part of the electrode body and at least a part of the plate are immersed in the electrolytic solution.

2. The method of manufacturing a battery according to claim 1, wherein a direction of the groove of the plate is perpendicular to a liquid level.

3. The method of manufacturing a battery according to claim 1, wherein the surface of the plate at which the groove is formed is in contact with an end surface of the electrode body.

4. The method of manufacturing a battery according to claim 1, the method comprising:
causing at least a part of the electrolytic solution to move along the groove of the plate to a region above a liquid level.

5. The method of manufacturing a battery according to claim 1, the method comprising:
depressurizing the internal space of the exterior body.
